(19) United States
(12) Patent Application Publication
(10) Pub. No.: US 2013/0185981 A1
(43) Pub. Date: Jul. 25, 2013

(54) ELECTRONIC FIREARM SYSTEM

(71) Applicant: CALIN BRABANDT, PORTLAND, OR (US)

(72) Inventor: CALIN BRABANDT, PORTLAND, OR (US)

(21) Appl. No.: 13/748,705

(22) Filed: Jan. 24, 2013

Related U.S. Application Data
(60) Provisional application No. 61/590,081, filed on Jan. 24, 2012.

(51) Int. Cl. F41G 1/35; F41G 1/00; H01H 35/02

(52) U.S. Cl. CPC F41G 1/35; H01H 35/02; F41G 1/00
USPC 42/117; 307/116; 42/132

(57) ABSTRACT

An apparatus, a system, and a method of operation relating to an electronic firearm system are disclosed. As one example embodiment, one or more tilt switches and/or tilt sensors are provided on-board the firearm. These tilt switches and/or tilt sensor may activate or deactivate electronics on-board the firearm responsive to different orientations or tilt states of the firearm. As another example embodiment, an energy storage device having one or more integrated tilt switches and/or tilt sensor is disclosed which varies an energy output of the energy storage device responsive to an orientation or tilt state of the energy storage device.

### CROSS-REFERENCE TO RELATED APPLICATION

The present application claims priority to U.S. Provisional Patent Application Ser. No. 61/590,081, titled ELECTRONIC FIREARM SYSTEM, filed Jan. 24, 2012, the entire contents of which are incorporated herein by reference in their entirety for all purposes.

### BACKGROUND

Electronic devices and in particular mobile electronic devices often rely on electrical energy stored on-board the device. For example, electronic devices carried on-board firearms, such as laser sights, flashlights, and/or illuminated indicators typically utilize energy from one or more batteries carried on-board the firearm.

### SUMMARY

An electronic firearm system is disclosed. As a non-limiting example, the electronic firearm system includes an electrical load, and one or more tilt switches that provide an electrical coupling between the electrical load and an energy source. At least one tilt switch may be adapted to open the electrical coupling responsive to a first tilt state of the tilt switch, and the tilt switch may be adapted to close the electrical coupling responsive to a second tilt state of the tilt switch. Accordingly, operation of the electrical load may be varied or at least partially controlled based on an orientation of the electronic firearm system, for example, relative to a gravitational vector. It will be appreciated that the above summary describes only some of the concepts covered in greater detail in the following detailed description. As such, claimed subject matter is not limited to the contents of this summary.

### BRIEF DESCRIPTION OF DRAWINGS

FIG. 1 is a schematic diagram depicting an example electronic firearm system according to one embodiment.

FIG. 2 is a schematic diagram depicting an example tilt switch according to one embodiment.

FIG. 3 is a schematic diagram depicting an example tilt sensor according to one embodiment.

FIG. 4 is a flow diagram depicting an example method according to one embodiment.

FIG. 5 is a schematic diagram depicting an example electronic firearm accessory according to one embodiment.

FIG. 6 is a schematic diagram depicting an example firearm including an integrated electronic firearm system according to one embodiment.

FIG. 7 is a schematic diagram depicting an example electronic circuit according to one embodiment.

FIG. 8 is a schematic diagram depicting an example energy storage device for an electronic device according to one embodiment.

### DETAILED DESCRIPTION

In some scenarios, the process of activating (e.g., turning on) or deactivating (e.g., turning off) electrical components may require that a user locate and select a button, switch, or other user control element. However, the act of locating these user control elements may be difficult, inconvenient, and/or time consuming for the user, particularly if the user is operating in an environment having low light conditions, or where the user is acting under stressful or time sensitive conditions. The disclosed electronic firearm system and energy storage device may address this issue by including one or more tilt switches and/or tilt sensors that are adapted to turn an electrical load on or off or otherwise augment power supplied to the load based on an orientation of the electronic firearm system or energy storage device, for example, relative to a gravitational vector.

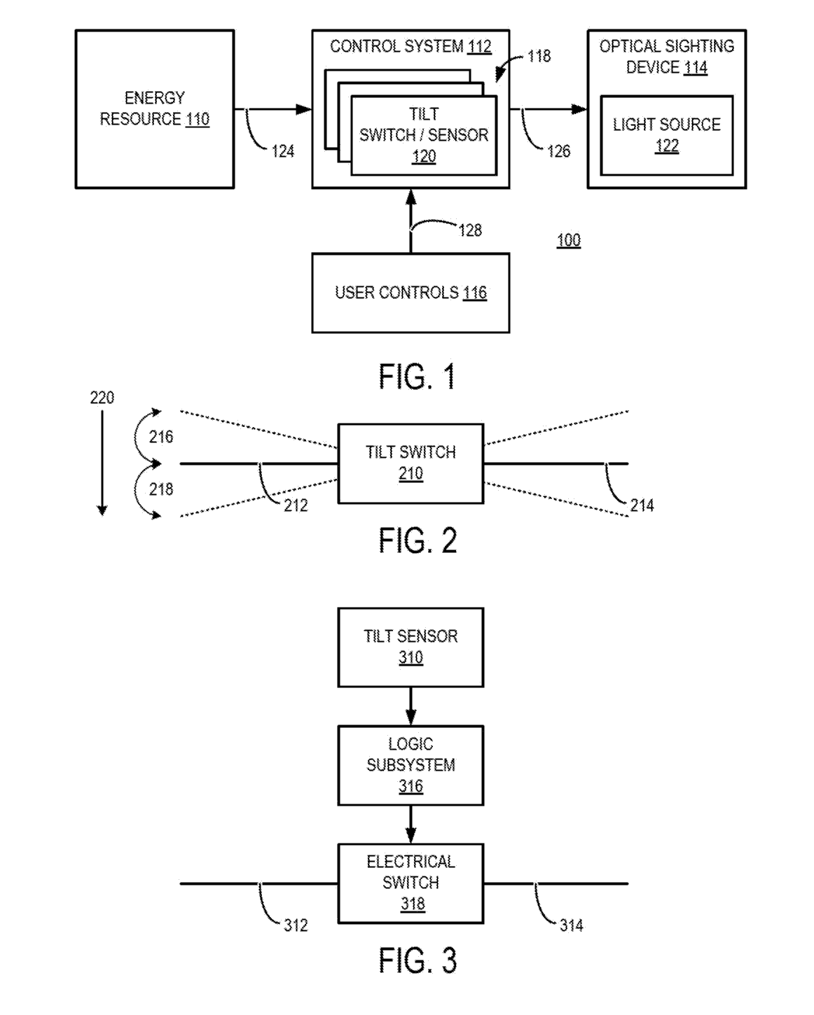

FIG. 1 is a schematic diagram depicting an example embodiment of an electronic firearm system 100, comprising one or more of energy resource 110, control system 112, optical sighting device 114, and user controls 116. In FIG. 1, arrows 124, 126, and 128 represent a flow of electrical energy and/or control signals, and may thereby include one or more of a positive electrical coupling, a negative electrical coupling, and a grounded electrical coupling, among others.

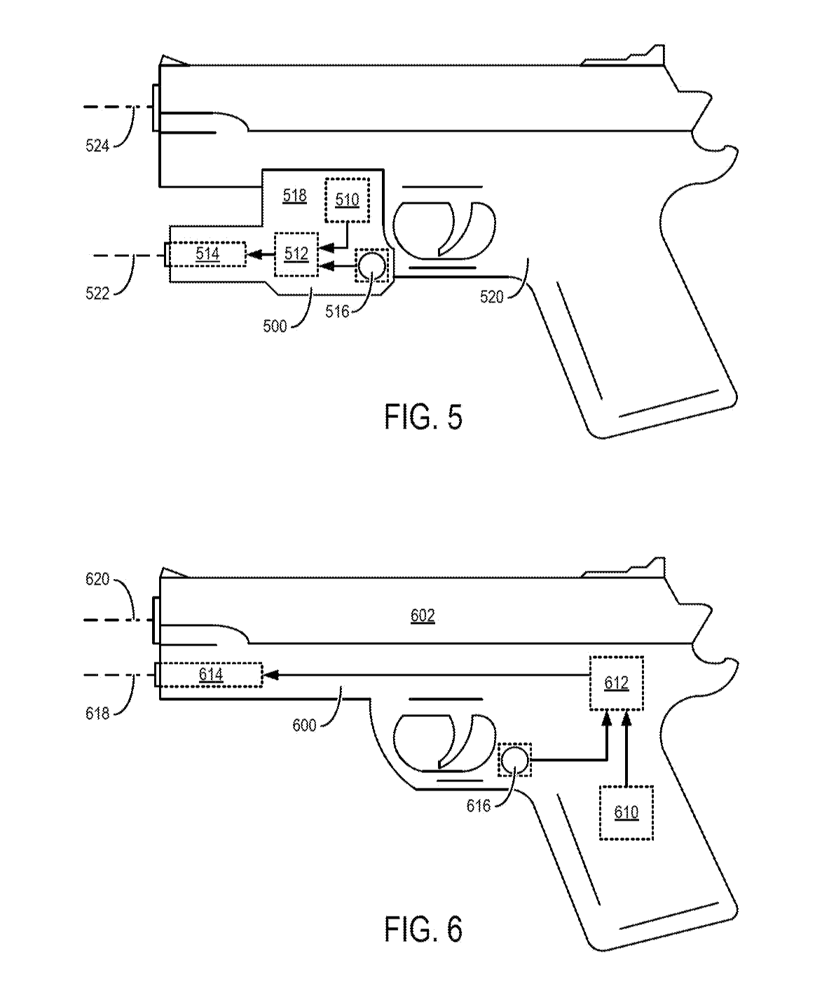

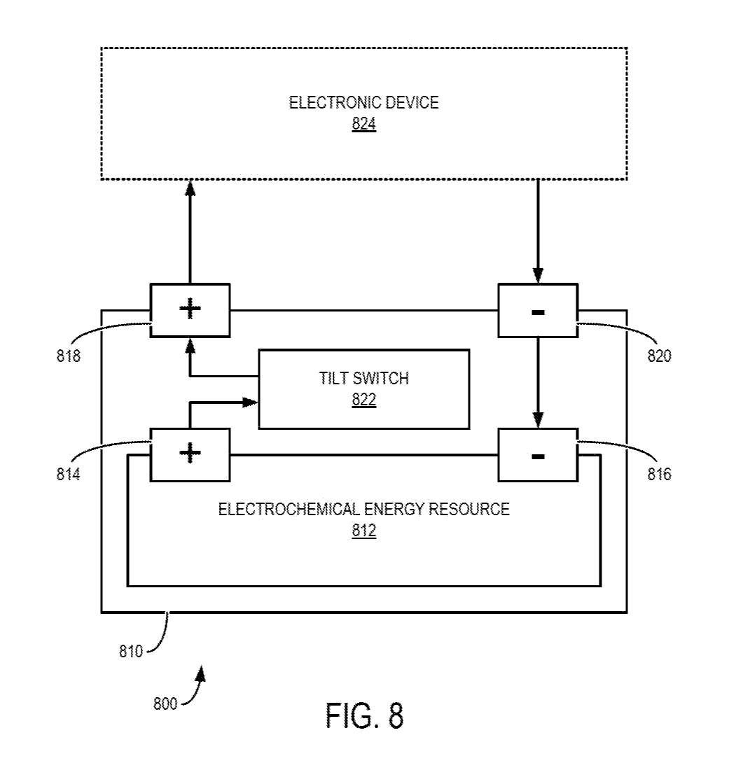

As will be described in greater detail, electronic firearm system 100 may be implemented in a number of ways with respect to a particular firearm. Briefly, electronic firearm system 100 may comprise an electronic firearm accessory in some implementations, for example, as described with reference to FIG. 5. In other implementations, electronic firearm system 100 may be integrated into the firearm itself, for example, as described with reference to FIG. 6. In still other implementations, at least a portion of electronic firearm system 100 may be integrated into an energy storage device and/or power supply such as an electrochemical battery for powering electronic components on-board a firearm or other electronic device, for example, as described with reference to FIG. 8.

Optical sighting device 114 may include one or more light sources such as light source 122 that may be powered, at least in part, by energy resource 110. Light source 122 may comprise an electrically powered light source in some examples, such as where energy resource 110 comprises an electrical or electrochemical energy resource. As a non-limiting example, light source 122 may comprise a LASER, a Light Emitting Diode (LED), light bulb, or other suitable light source. However, in other embodiments, optical sighting device 114 may instead take the form of any suitable electrical load that may be powered by energy resource 110.

Control system 112 may be adapted to control operation of optical sighting device 114 or other electronic device responsive to user inputs received via user controls 116 and/or orientation (e.g., tilt state) as measured or detected by one or more of tilt switches/sensors 118, such as example tilt switch/sensor 120. As a non-limiting example, control system 112 may be adapted to activate optical sighting device 114 (e.g., by turning on light source 122) or other electrical load responsive to tilt switch/sensor 120 measuring or detecting a first orientation, and may be adapted to deactivate optical sighting device 114 (e.g., by turning off or initiating a power-down sequence for light source 122) or other electrical load responsive to tilt switch/sensor 120 measuring or detecting a second orientation. In this way, a human operator may activate or deactivate optical sighting device 114 or other electrical load by varying an orientation of electronic firearm system 100. Tilt switches/sensors 118 will be described in greater detail with reference to FIGS. 2, 3, and 7.

User controls 116 may include one or more user input interfaces or user control elements for receiving user input indicative of a user setting or preference. Control system 112 may be adapted to receive an indication of the user setting or preference via user controls 116, and may vary a mode of operation of optical sighting device 114 or other electrical load responsive to the indicated user setting or preference. As a non-limiting example, user controls 116 may include a mode selector switch for varying an orientation datum or orientation range utilized for activating and/or deactivating optical sighting device 114 or other electrical load. As will be described in greater detail herein, an orientation datum or orientation range utilized for performing a particular function with respect to optical sighting device 114 or other electrical load may be varied (e.g., via control system 112) by selecting which tilt switches/sensors 118 or which combination of tilt switches/sensors 118 are referenced to obtain an indication of orientation. However, in at least some embodiments, user controls 116 may be omitted.

FIG. 2 is a schematic diagram depicting an example implementation of a tilt switch 210, which may correspond to tilt switch/sensor 120 of FIG. 1. As schematically depicted in FIG. 2, tilt switch 210 may provide an electrical coupling between a downstream side 212 and an upstream side 214 of an electronic circuit. Tilt switch 210 may be configured to open or close the electrical coupling between downstream side 212 and upstream side 214 responsive to a measured orientation. For example, the tilt switch may be adapted to open the electrical coupling responsive to a first tilt state to inhibit electrical energy from flowing between downstream side 212 and upstream side 214, and to close the electrical coupling responsive to a second tilt state to permit electrical energy from flowing between downstream side 212 and upstream side 214. As a non-limiting example, downstream side 212 may communicate with an energy resource such as previously described energy resource 110, and upstream side 214 may communicate with an electrical load such as previously optical sighting device 114.

Tilt switch 210 may have a first orientation range (e.g., relative to the gravitational vector) that corresponds to an open state and a second orientation range that corresponds to a closed state. These first and second orientation ranges may take any suitable value. As one example, in FIG. 2, tilt switch 210 has an orientation range 30 degrees above (e.g., indicated at 216) and 30 degrees (e.g., indicated at 218) below a horizontal plane orthogonal to the gravitational vector 220 in which the tilt switch is open. As the tilt switch is rotated beyond or outside of this orientation range, the tilt switch closes to enable current to flow between 212 and 214.

FIG. 3 is a schematic diagram depicting an example implementation of a tilt sensor 310, which may correspond to tilt switch/sensor 120 of FIG. 1. Tilt sensor 310 may be distinguished from tilt switch 210 of FIG. 2 as instead including a passive sensor element rather than an active switch for opening and closing an electrical coupling between downstream side 312 and upstream side 314. Hence, as further shown in FIG. 3, tilt sensor 310 may be implemented in combination with a logic subsystem 316 and an electrical switch 318 to open and close the electrical coupling between downstream side 312 and upstream side 314. As previously described with reference to FIG. 2, any suitable orientation range may be supported by the tilt sensor and logic subsystem for opening and closing electrical switch 318.

In at least some implementations, logic subsystem 316 may comprise a computing platform including one or more microprocessors and/or storage media (e.g., RAM, ROM, Flash Memory, optical storage, magnetic storage, etc.). This storage media may have instructions stored thereon that are executable by a microprocessor to perform one or more operations, such as receiving an indication of an orientation from tilt sensor 310, and opening or closing electrical switch 318 responsive to the indicated orientation. In other implementations, logic subsystem 316 may comprise one or more electronic circuits for performing one or more of the previously described operations, such as receiving an indication of an orientation from tilt sensor 310, and opening or closing electrical switch 318 responsive to the indicated orientation. Hence, it will be appreciated that control system 112 may include one or more of the example implementations depicted in FIGS. 2 and 3 with respect to tilt switches and tilt sensors, respectively.

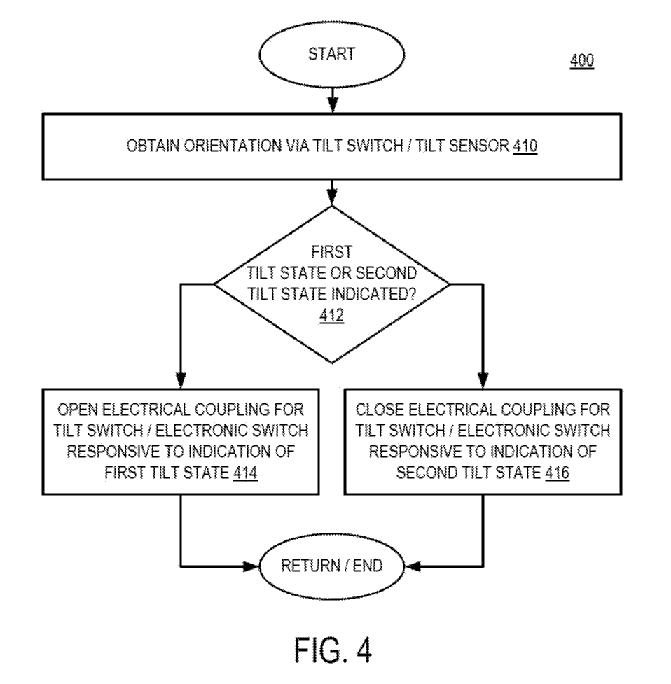

FIG. 4 is a flow diagram depicting an example method 400. In at least some implementations, method 400 may be performed by a control system, such as previously described control system 112. As a non-limiting example, method 400 may be performed by a computing platform executing instructions, such as previously described with respect to logic subsystem 316.

At 410, method 400 may include obtaining an orientation via a tilt switch or a tilt sensor. At 412, if the orientation obtained at 410 indicates a first tilt state, then the process flow of method 400 may proceed to 414. At 414, an electrical coupling for the tilt switch or tilt sensor may be opened responsive to the indication of the first tilt state. For example, for a tilt switch, the tilt switch may open the electrical coupling responsive to an orientation indicating the first tilt state. As another example, for a tilt sensor, an electronic switch associated with the tilt sensor may be operated (e.g., by a logic subsystem) to open the electrical coupling responsive to an orientation indicating the first tilt state.

Alternatively, if the orientation obtained at 410 indicates a second tilt state, then the process flow of method 400 may instead proceed to 416. At 416, the electrical coupling for the tilt switch or tilt sensor may be closed responsive to the indication of the second tilt state. For example, for a tilt switch, the tilt switch may close the electrical coupling responsive to an orientation indicating the second tilt state. As another example, for a tilt sensor, an electronic switch associated with the tilt sensor may be operated (e.g., by a logic subsystem) to close the electrical coupling responsive to an orientation indicating the second tilt state.

FIG. 5 is a schematic diagram depicting an example embodiment of an electronic firearm accessory 500. It will be appreciated that electronic firearm accessory 500 may refer to an example implementation of electronic firearm system 100 of FIG. 1. Electronic firearm accessory 500 may comprise one or more of a power supply 510, a control system 512, an optical sighting device 514, and user controls 516. Power supply 510 may correspond to an example implementation of energy resource 110 of FIG. 1. As such, power supply 510 may include one or more electrochemical batteries, for example. Control system 512 may correspond to an example implementation of control system 112 of FIG. 1. As such, control system 512 may include one or more tilt switches and/or tilt sensors (including associated logic and/or electronic switches) for varying operation of optical sighting device 514 responsive to a measured or detected orientation. Optical sighting device 514 may correspond to an example implementation of optical sighting device 114 of FIG. 1. As such, optical sighting device 514 may include a laser, an LED, or other suitable light source that may be powered by power supply 510. User controls 416 may correspond to an example implementation of user controls 116 of FIG. 1. As such, user controls 516 may include one or more mode selectors for varying operation of the optical sighting device responsive to orientation.

Electronic firearm accessory 500 may further comprise an accessory body 518 to couple components 510, 512, 514, and 516 to firearm 520. As depicted in the example implementation of FIG. 5, optical sighting device 514 is oriented to project light along axis 522 which is parallel to an axis 524 of the barrel of firearm 520. However, in other implementations, optical sighting device 514 may project light in other suitable directions and/or may be used to illuminate features of the firearm itself.

FIG. 6 is a schematic diagram depicting an example embodiment of a firearm including an integrated electronic firearm system 600. It will be appreciated that electronic firearm system 600 may refer to an example implementation of electronic firearm system 100 of FIG. 1. Electronic firearm system 600 may include one or more of a firearm body 602, power supply 610, control system 612, optical sighting device 614, and user controls 616. Power supply 610 may correspond to an example implementation of energy resource 110 of FIG. 1. As such, power supply 610 may include one or more electronic batteries, for example. Control system 612 may correspond to an example implementation of control system 112 of FIG. 1. As such, control system 612 may include one or more tilt switches and/or tilt sensors (including associated logic and/or electronic switches) for varying operation of optical sighting device 614 or other suitable electrical load responsive to an orientation of firearm 600. Optical sighting device 614 may correspond to an example implementation of optical sighting device 114 of FIG. 1. As such, optical sighting device 614 may include a laser, an LED, or other suitable light source that may be powered by power supply 610. User controls 616 may correspond to an example implementation of user controls 116 of FIG. 1. As such, user controls 616 may include one or more mode selectors. As depicted in the example implementation of FIG. 6, optical sighting device 614 is oriented to project light along axis 618, which is parallel to an axis 620 of the barrel of the firearm. However, in other implementations, optical sighting device 614 may project light in other suitable directions and/or may be used to illuminate features of the firearm itself.

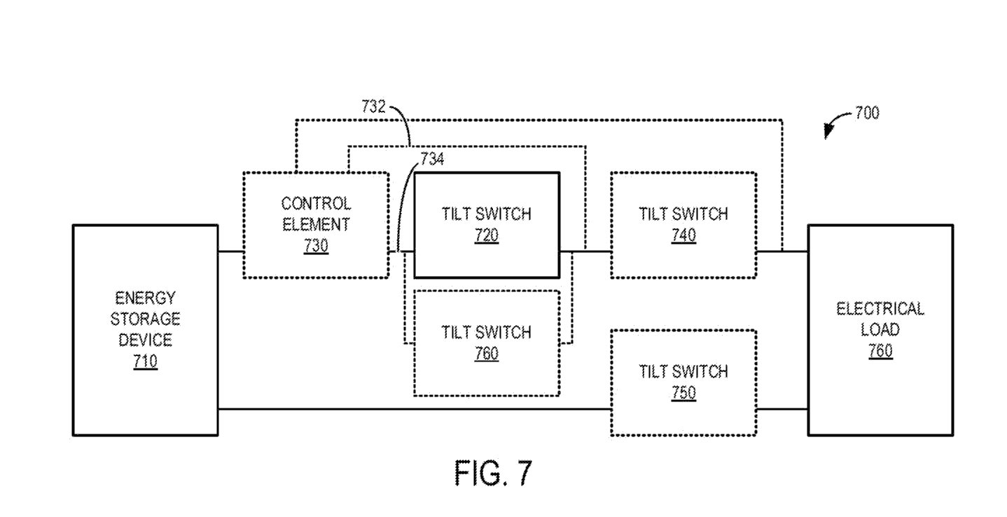

FIG. 7 is a schematic diagram depicting an example electronic circuit 700. Electronic circuit 700 includes an energy storage device 710 (e.g., a battery or other electrical power supply) supplying electrical energy to an electrical load 760. At least one tilt switch 720 is disposed between energy storage device 710 and electrical load 760. If tilt switch 720 is open at certain orientations, electrical energy is not permitted to flow across tilt switch 720. If tilt switch 720 is closed at other orientations, electrical energy is permitted to flow across tilt switch 720.

A control element 730 may be disposed between energy storage device 710 and electrical load 760 in series with tilt switch 720 via path 734 and/or in parallel with tilt switch 720 via path 732. Control element may be configured to enable electrical energy to flow via one or more of paths 732 and/or 734. If electrical energy is permitted to flow via path 734 and not permitted to flow via path 732, then tilt switch 720 controls the flow of electrical energy from energy storage device 710 and electrical load 760. However, if electrical energy is permitted to flow via path 732, then electrical energy may still flow from energy storage device 710 to electrical load 760 even if tilt switch 720 is open. For example, this parallel configuration may be provided in order to maintain the supply of electrical energy to electrical load 760 responsive to a user control element being set to an “on” or “bypass” setting for the electrical load. As another example, this parallel configuration may be provided in order to maintain the supply of electrical energy to electrical load 760 for a period of time after the tilt switch is opened. Any suitable period of time may be supported by control element 730 (e.g., 10 seconds, 1 minute, 1 hour, etc.). For example, the control element may include or may be controlled by a timer circuit or computing platform implementing a timer program. The timer circuit or timer program may be adjustable or programmable by the user to set the period of time.

FIG. 7 also depicts how an electronic circuit 700 may include additional tilt switches, such as tilt switch 740 in series and/or parallel configuration with tilt switch 720. The particular configuration may be again based on a flow path provided by a control element such as control element 730. Electronic circuit 700 may include a tilt switch 750 in series with tilt switch 720 as high (+) and low signal (−) component switches, for example. With two tilt switches in a series configuration, each switch must be closed for electrical energy to flow via these switches. With two tilt switches in a parallel configuration, however, electrical energy may flow from energy storage device 710 to electrical load 760 if either of the parallel switches is closed. Electronic circuit 700 may include a tilt switch 760 in parallel with tilt switch 720. With two tilt switches in a parallel configuration, electrical energy may still flow to electrical load 760 if either of the parallel switches is closed.

Two or more switches may be used in combination to provide any suitable control configuration for powering the electrical load. For example, a first tilt switch may be in a closed state enabling electrical energy to flow via the first tilt switch if circuit 700 is orientated within a first range relative to a gravity vector within a first plane. In the context of a firearm, this first orientation range may correspond to the axis of the firearm barrel being within 60 degrees above and 60 degrees below a horizontal plane orthogonal to the gravity vector. For example, the firearm may be in an off position or in a timed power down state if holstered such that the barrel axis points downward. However, other suitable ranges may be supported. A second tilt switch may be in a closed state enabling electrical energy to flow via the second tilt switch if circuit 700 is orientated within a second range relative to the gravity vector within a second plane that is angled relative to the first plane. In the context of a firearm, this second orientation range may correspond to a vertical plane of the firearm that contains the barrel axis and the gravitational vector being within 60 degrees on either side of vertical. For example, the firearm may be in an off position or in a timed power down state if laying on its side horizontal surface. A third tilt switch may be in a closed state enabling electrical energy to flow via the third tilt switch if circuit 700 is orientated within a third range relative to the gravity vector with the first plane, the second plane, or yet a third plane that is angled relative to the first and second planes.

It will be understood that any suitable configuration of one, two, three, or more tilt switches and/or sensors may be provided in series, parallel, or a combination of series and parallel configurations to provide a desired power supply profile between an electrical energy resource and an electrical load that is responsive to the orientation of the system relative to a gravitational vector. These configurations may be selectable by a user via user controls, such as previously described with respect to user controls 116 of FIG. 1.

FIG. 8 is a schematic diagram depicting an example embodiment of an energy storage device 800 for powering an electrical load, such as example electronic device 824. FIG. 8 shows an example where an energy storage device, such as an electrochemical battery, may include one or more tilt switches and/or tilt sensors (including associated logic and an electronic switch) for varying energy output of the energy storage device to an electronic device responsive to an orientation of the energy storage device as detected by one or more tilt switches and/or tilt sensors.

Energy storage device 800 may comprise a device body 810 and an electrochemical energy resource 812 disposed within the device body. Electrochemical energy resource may comprise one or more electrochemical voltaic or galvanic cells. Accordingly, electrochemical energy resource 812 may include a cathode 814 and an anode 816, which are depicted as having positive and negative charges, respectively. However, it will be appreciated that the polarity of the cathode and anode may differ in other implementations.

Energy storage device 800 may further include a cathode terminal 818 disposed on and/or accessible at an outer surface of device body 810, which is electrically coupled to electrochemical energy resource 812 via cathode 814. Energy storage device 800 may further include an anode terminal 820 disposed on and/or accessible at an outer surface of device body 810, which is electrically coupled to electrochemical energy resource 812 via anode 816. In this particular implementation, cathode terminal 818 is electrically coupled to electrochemical energy resource 812 via tilt switch 822. However, in other implementations, anode terminal 820 may be electrically coupled to electrochemical energy resource 812 via one or more tilt switches and/or tilt sensors, such as example tilt switch 822. Tilt switch 822 may provide an electrical coupling between the anode terminal and the anode and/or the cathode terminal and the cathode. It will be understood that energy storage device 800 may utilize any of the previously described circuits having one, two, three, or more tilt switches and/or sensors in parallel and/or series configuration as described herein, for example, with reference to FIG. 7.

Tilt switch 822 may be disposed on an outer surface and/or at least partially within device body 810. Tilt switch 822 may be adapted to open the electrical coupling between the cathode and the cathode terminal or the anode and the anode terminal responsive to a first tilt state of the tilt switch to disrupt or prevent current from flowing between cathode terminal 818 and anode terminal 620 (e.g., via electronic device 824). The tilt switch may be further adapted to close the electrical coupling responsive to a second tilt state of the tilt switch to enable current to flow between cathode terminal 818 and anode terminal 820 (e.g., via electronic device 824). In this example, the first tilt state may correspond to a different tilt angle relative to a gravitational vector than the second tilt state.

It will be appreciated that energy storage device 800 of FIG. 8 may comprise portions of previously described electronic firearm system 100 of FIG. 1. For example, electrochemical energy resource 812 may correspond to an example implementation of energy resource 110 and tilt switch 822 may correspond to an example implementation of tilt switch/sensor 120. Hence, in at least some implementations, energy storage device 800 may be used to power an optical sighting device of a firearm, such as previously described optical sighting device 114 of FIG. 1. However, it will also be appreciated that energy storage device 800 may be used to power any suitable electronic device, including for example, mobile electronic devices such as cell phones, mobile computers, power tools, etc.

In some implementations, energy storage device 800 may further comprise a second tilt switch (not shown). The second tilt switch may provide a second electrical coupling between the anode terminal and the anode or the cathode terminal and the cathode. This second tilt switch may be adapted to open the second electrical coupling responsive to a third tilt state of the second tilt switch and close the second electrical coupling responsive to a fourth tilt state of the second tilt switch. Again, in this example, the third tilt state may correspond to a different tilt angle relative to a gravitational vector than the fourth tilt state.

It should be understood that the disclosed embodiments are illustrative and not restrictive. Variations to the disclosed embodiments that fall within the metes and bounds of the claims or equivalence of such metes and bounds are intended to be embraced by the claims.

1. An electronic firearm accessory, comprising:
an optical sighting device including an electrically powered light source;
a first electrical terminal to communicate with an anode terminal of a power supply;
a second electrical terminal to communicate with a cathode terminal of the power supply; and
a tilt switch providing an electrical coupling between the electrically powered light source and at least one of the first electrical terminal and the second electrical terminal, the tilt switch to open the electrical coupling responsive to a first tilt state of the tilt switch, and the tilt switch to close the electrical coupling responsive to a second tilt state of the tilt switch.

2. The electronic firearm accessory of claim 1, wherein the second tilt state corresponds to a greater tilt angle relative to a gravitational vector than the first tilt state.

3. The electronic firearm accessory of claim 1, wherein the electrically powered light source comprises one or more of a laser and a light emitting diode.

4. The electronic firearm accessory of claim 1, further comprising a master power switch providing a second electrical coupling between the electrically powered light source and at least one of the first electrical terminal and the second electrical terminal, the master power switch including a first position to close the second electrical coupling and a second position to open the second electrical coupling.

5. The electronic firearm accessory of claim 1, wherein the tilt switch is a first tilt switch, and wherein the electronic firearm accessory further comprises a second tilt switch providing a second electrical coupling between the electrically powered light source and at least one of the first electrical terminal and the second electrical terminal, the second tilt switch to open the second electrical coupling responsive to a third tilt state of the second tilt switch, and the second tilt switch to close the second electrical coupling responsive to a fourth tilt state of the second tilt switch.

6. The electronic firearm accessory of claim 5, wherein a tilt angle between the first tilt state and the second tilt state of the first tilt switch is different than a tilt angle between the third tilt state and the fourth tilt state of the second tilt switch.

7. The electronic firearm accessory of claim 5, wherein a tilt angle between the first tilt state and the second tilt state of the first tilt switch is substantially the same as a tilt angle between the third tilt state and the fourth tilt state of the second tilt switch.

8. The electronic firearm accessory of claim 5, wherein a tilt axis of the first tilt switch is parallel to a tilt axis of the second tilt switch; and wherein the first tilt switch is spaced apart from the second tilt switch.

9. The electronic firearm accessory of claim 5, wherein a tilt axis of the first tilt switch is angled relative to a tilt axis of the second tilt switch.

10. The electronic firearm accessory of claim 5, further comprising a mode selector switch including a first position corresponding to a series mode wherein the first tilt switch and the second tilt switch are electrically coupled in series between the electrically powered light source and the at least one of the first electrical terminal and the second electrical terminal, the mode selector switch including a second position corresponding to a parallel mode wherein the first tilt switch and the second tilt switch are electrically coupled in parallel between the electrically powered light source and the at least one of the first electrical terminal and the second electrical terminal.

11. The electronic firearm accessory of claim 5, further comprising a mode selector switch including a first position wherein the first tilt switch and the second tilt switch are electrically coupled in series or parallel between the electrically powered light source and the at least one of the first electrical terminal and the second electrical terminal, the mode selector switch including a second position wherein one of the first tilt switch and the second tilt switch is short circuited between the electrically powered light source and the at least one of the first electrical terminal and the second electrical terminal.

12. The electronic firearm accessory of claim 1, further comprising, an accessory body to couple the first electrical terminal, the second electrical terminal, the optical sighting device, and the tilt switch to a firearm.

13. The electronic firearm accessory of claim 1, further comprising the power supply, wherein the power supply comprises an electric battery including the anode terminal and the cathode terminal.

14. The electronic firearm accessory of claim 1, wherein the tilt switch comprises a tilt sensor and an electronic computing platform including a processor, the processor programmed with instructions to:
obtain an indication of tilt angle relative to a gravitational vector from the tilt sensor; and
open or close the electrical coupling of the tilt switch responsive to the indication of the tilt angle.

15. A firearm, comprising:
a firearm body;
an optical sighting device including an electrically powered light source;
a first electrical terminal to communicate with an anode terminal of a power supply;
a second electrical terminal to communicate with a cathode terminal of the power supply; and
a tilt switch providing an electrical coupling between the electrically powered light source and at least one of the first electrical terminal and the second electrical terminal, the tilt switch to open the electrical coupling responsive to a first tilt state of the tilt switch, and the tilt switch to close the electrical coupling responsive to a second tilt state of the tilt switch.

16. The firearm of claim 15, wherein the second tilt state corresponds to a greater tilt angle relative to a gravitational vector than the first tilt state; and wherein the electrically powered light source comprises one or more of a laser; a light emitting diode; and a light bulb.

17. The firearm of claim 15, wherein the tilt switch is a first tilt switch, and wherein the firearm further comprises a second tilt switch providing a second electrical coupling between the electrically powered light source and at least one of the first electrical terminal and the second electrical terminal, the second tilt switch to open the second electrical coupling responsive to a third tilt state of the second tilt switch, and the second tilt switch to close the second electrical coupling responsive to a fourth tilt state of the second tilt switch.

18. The firearm of claim 17, further comprising a mode selector switch including a first position corresponding to a series mode wherein the first tilt switch and the second tilt switch are electrically coupled in series between the electrically powered light source and the at least one of the first electrical terminal and the second electrical terminal, the mode selector switch including a second position corresponding to a parallel mode wherein the first tilt switch and the second tilt switch are electrically coupled in parallel between the electrically powered light source and the at least one of the first electrical terminal and the second electrical terminal.

19. An energy storage device to power an electronic device, comprising:
a device body;
an electrochemical energy resource disposed within the device body, the electrochemical energy resource including an anode and a cathode;
an anode terminal disposed on an outer surface of the device body and electrically coupled to the electrochemical energy resource via the anode;
a cathode terminal disposed on an outer surface of the device body and electrically coupled to the electrochemical energy resource via the cathode; and
a tilt switch disposed on or within the device body, the tilt switch providing an electrical coupling between the anode terminal and the anode or the cathode terminal and the cathode, the tilt switch to open the electrical coupling responsive to a first tilt state of the tilt switch, the tilt switch to close the electrical coupling responsive to a second tilt state of the tilt switch, and the first tilt state corresponding to a different tilt angle relative to a gravitational vector than the second tilt state.

20. The energy storage device of claim 19, wherein the electrochemical energy resource comprises one or more electrochemical voltaic or galvanic cells; and
wherein the tilt switch is a first tilt switch, and wherein the energy storage device further comprises a second tilt switch providing a second electrical coupling between the anode terminal and the anode or the cathode terminal and the cathode, the second tilt switch to open the second electrical coupling responsive to a third tilt state of the second tilt switch, the second tilt switch to close the second electrical coupling responsive to a fourth tilt state of the second tilt switch, and the third tilt state corresponding to a different tilt angle relative to a gravitational vector than the fourth tilt state.
